(19) United States
(12) Patent Application Publication
(10) Pub. No.: US 2005/0173897 A1
(43) Pub. Date: Aug. 11, 2005

(54) Airbag apparatus

(75) Inventors: Kazuhiro Abe, Chaussee Strasse (DE); Rika Senoh, Hikone-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/045,347

(22) Filed: Jan. 31, 2005

(30) Foreign Application Priority Data
Feb. 6, 2004 (JP) 2004-030996
Mar. 8, 2004 (JP) 2004-064555

(51) Int. Cl. B60R 21/24; B60R 21/26

(52) U.S. Cl. 280/729; 280/736

(57) ABSTRACT

An airbag apparatus includes an airbag that is defined by a plurality of chambers or by a plurality of small airbags. The airbag is configured in such a manner that not only the sequence of inflation of the respective chambers or airbags, but also the internal pressure upon inflation, is controlled independently. The airbag apparatus includes an inflator for inflating the airbag, a flow control member for allowing gas from the inflator to flow independently into the chambers or airbags, and a retainer. The inflator includes two gas generating units, which are configured to perform gas generating action independently. The flow control member is configured to allow gas from the first gas generating unit to flow into a first chamber or a first small airbag of the airbag, and gas from the second gas generating unit to flow into a second chamber or a second small airbag of the airbag.

### BACKGROUND

The present invention relates to an airbag apparatus that is to be installed in a vehicle and that includes an airbag and an inflator for inflating the airbag.

Conventionally, when a collision of a vehicle is detected by a sensor, an inflator is activated and generates gas that inflates an airbag. Japanese Unexamined Patent Application Publication No. 2-74440 disloses a driver's side airbag in which the interior of the airbag is divided into a center chamber and two peripheral chambers by partitioning panels; the center chamber is inflated first followed by an inflation of the peripheral chambers. The partitioning panels, which are formed with through holes facilitating gas flow, connect the rear side and the front side of the airbag and act to prevent the airbag from projecting forward when inflated.

In contrast to Japanese Unexamined Patent Application Publication No. 2-74440, U.S. Pat. No. 6,254,121 discloses a driver's side airbag apparatus that is configured to inflate the peripheral chambers first followed by an inflation of the center chamber.

In both of these airbag apparatuses, only one inflator is provided. In Japanese Unexamined Patent Application Publication No. 2-74440, the inflator is installed so as to inject gas into the center chamber whereas in U.S. Pat. No. 6,254,121, the inflator is installed so as to inject gas into the peripheral chambers. In both of these airbag apparatuses, although the sequence of inflation of the center chamber and the peripheral chambers is controlled, the inner pressure (and timing thereof) of the respective chambers cannot be independently controlled.

Accordingly, the present invention has been made in light of the aforementioned problems. An object of the present invention is to provide an airbag apparatus that includes an airbag having a plurality of chambers (or a plurality of airbags) in which both of the following can be controlled independently: (a) the sequence of inflation of the respective chambers (or the respective airbags) and (b) the internal pressure of the chambers (or airbags) when inflated.

### SUMMARY

An embodiment of the invention, addresses an airbag apparatus that includes, among other possible things: an airbag having a plurality of chambers; and a gas generator configured to inflate the airbag. A supply of gas from the gas generator to at least one of the chambers is controlled independently from a supply of gas from the gas generator to other chambers.

In a further embodiment of this airbag apparatus, the gas generator may include an inflator having a plurality of gas generating units that are configured to perform gas generating action independently. Further, gas from the gas generating units may be respectively supplied to the chambers.

In another further embodiment of this airbag apparatus, the gas generator may include a plurality of inflators that are configured to perform gas generating action independently. Further, gas from the inflators may be respectively supplied to the chambers.

In another further embodiment of this airbag apparatus, the airbag apparatus may be part of a vehicle.

In this airbag apparatus embodiment, the supply of gas to at least one of the chambers (out of the plurality of chambers in the airbag) may be controlled independently from the supply of gas to other chambers. As a result, by independently controlling the timing of activation or output of the gas generator, both of the following can be independently controlled: (a) the sequence of inflation of respective chambers in the airbag; and (b) the internal pressure of the respective chambers (when inflated).

Another embodiment of the invention addresses airbag apparatus that includes, among other possible things: a plurality of airbags; and gas generator configured to inflate respective airbags. A supply of gas from the gas generator to at least one of the airbags is controlled independently from a supply of gas from the gas generator to other airbags.

In a further embodiment of this airbag apparatus, the gas generator may include an inflator having a plurality of gas generating units that are configured to perform gas generating action independently. Further, gas from the gas generating units may be respectively supplied to the airbags.

In another further embodiment of this airbag apparatus, the gas generator may include a plurality of inflators that are configured to perform gas generating action independently. Further, gas from the inflators may be respectively supplied to the airbags.

In another further embodiment of this airbag apparatus, the airbag apparatus may be part of a vehicle.

In this airbag apparatus embodiment, even when a plurality of airbags are provided, the supply of gas to at least one of the airbags (out of the plurality of airbags) may be controlled independently from the supply of gas to other airbags. As a result, by independently controlling the timing of activation or output of the respective inflators, both of the following may be controlled independently: (a) the sequence of inflation of respective airbags; and (b) the internal pressure of the respective airbags when inflated.

The present invention may be configured such that the gas generator includes: (a) an inflator having a plurality of gas generating units; or (b) a plurality of inflators. Depending on the embodiment, the gas generating units or the inflators may be configured to perform gas generation action independently. Gas from the respective gas generating units or inflators may be supplied separately to the respective chambers or airbags.

In embodiments in which the gas generator includes the inflator having a plurality of gas generating units, as the gas may be supplied to the plurality of chambers (or airbags) respectively from one inflator, the number of components of the airbag apparatus can be reduced. In contrast, in embodiments in which the gas generator includes a plurality of inflators, the flexibility of the layout of the inflators with respect to the respective chambers or airbags is increased.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a vertical, cross-sectional view of an airbag apparatus according to an embodiment of the present invention;

FIG. 2(a) is an exploded, perspective view of a flow control member (i.e., gas flow path defining member) of the airbag apparatus in FIG. 1;

FIG. 2(b) is a perspective view of the flow control member of FIG. 2(a) in an assembled state;

FIG. 3 is an exploded perspective view of the airbag apparatus in FIG. 1;

FIG. 4 is a vertical, cross-sectional view of an airbag apparatus according to a second embodiment of the present invention;

FIG. 5 is a vertical, cross-sectional view of an airbag apparatus according to a third embodiment of the present invention;

FIG. 6 is an exploded, perspective view of the airbag apparatus shown in FIG. 5;

FIG. 7 is a vertical, cross-sectional view of an airbag apparatus according to a fourth another embodiment of the present invention;

FIG. 8 is a perspective view of an alternate embodiment flow control member that can be used in the airbag apparatus embodiments shown in FIGS. 1, 4, 5, and 7; and

FIG. 9 is an exploded, perspective view of another alternate embodiment flow control member that can be used in the airbag apparatus embodiments shown in FIGS. 1, 4, 5, and 7.

### DETAILED DESCRIPTION

Embodiments of the present invention will be described with reference to the drawings. Like numbers are used throughout the drawings to refer to the same or similar parts in each of the embodiments of the invention described herein.

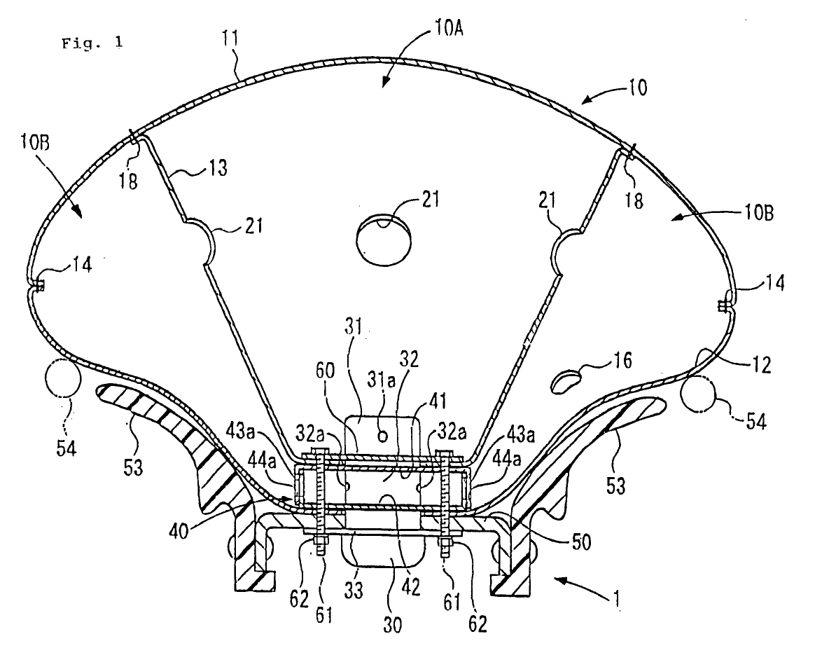

FIG. 1 shows an airbag apparatus 1 that includes: (a) an airbag 10 having an interior partitioned into first and second chambers 10A, 10B; (b) an inflator (also referred to as a “gas generator”) 30 for inflating the airbag 10; (c) a flow control member (also referred to as a “gas flow path defining member”) 40 for allowing gas from the inflator 30 to flow independently into the first and second chambers 10A, 10B; and (d) a retainer 50 to which the airbag 10, the inflator 30, and the flow control member 40 are attached.

In this embodiment, the inflator 30 includes two gas generating units 31, 32 that are configured to generate gas independently. The flow control member 40 allows gas from the first gas generating unit 31 to flow into the first chamber 10A and gas from the second gas generating unit 32 to flow into the second chamber 10B.

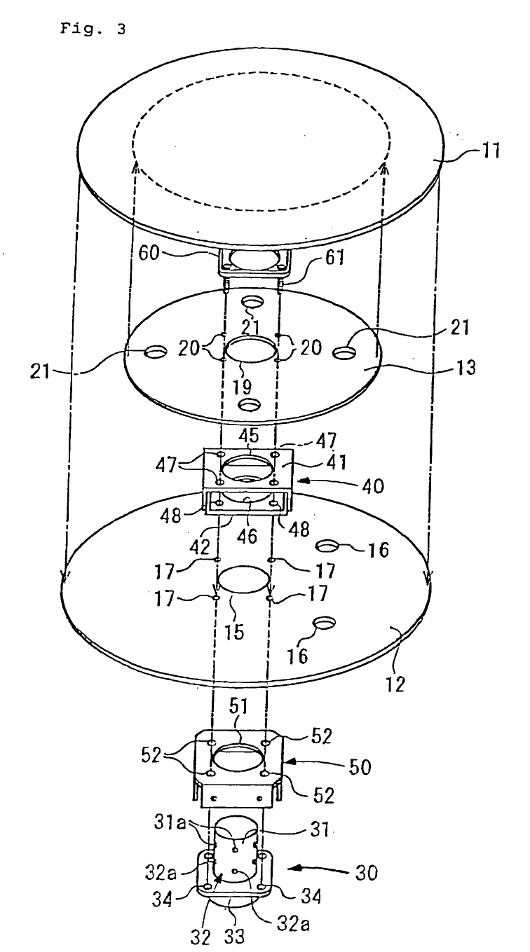

The airbag 10 includes a front panel 11, a rear panel 12, and an inner panel 13, which are formed of circular fabric respectively, as shown in FIG. 3. The front panel 11 and the rear panel 12 have substantially the same diameter, and are joined by stitching around the outer periphery thereof by a seam 14 formed of a yarn or the like to form a bag-shaped airbag envelope. For sake of viewing simplicity, only the sections of the seam 14 that are in cross-section are shown. The seam 14, however, of course circumscribes the airbag 10, i.e., the seam 14 has an annular shape extending along the outer peripheral portions of the front panel 11 and the rear panel 12.

The rear panel 12 is formed with an opening 15 for an inflator 30 and a plurality of vent holes 16. The opening 15 for the inflator 30 is disposed at the center of the rear panel 12. Bolt insertion holes 17 are formed around the opening 15.

The inner panel 13, which is provided inside the airbag 10, is disposed substantially concentrically with the front and rear panels 11,12. A distal peripheral portion (i.e., the portion that, when inflated, is away from the inflator 30, as shown in FIG. 1) of the inner panel 13 is stitched by a seam 18 (formed of, e.g., yarn or the like) to an intermediate portion of the front panel 11, which is between a center portion and a peripheral portion (i.e., the portion attached to rear panel 12) of the front panel 11. For sake of viewing simplicity, only the sections of the seam 18 that are in cross-section are shown; the seam 18, however, of course circumscribes the distal end of the inner panel 13. The interior of the airbag 10 is partitioned by the inner panel 13 into the first chamber 10A and the second chamber 10B, which surround the first chamber 10A. The first chamber 10A corresponds to the inside of the inner panel 13.

An opening 19 for the inflator 30 is formed in a center portion (i.e., at a portion that corresponds to the end of the inner panel 13, when inflated as shown in FIG. 1, proximal to the inflator 30) of the inner panel 13. The opening 19 is disposed substantially concentrically with the opening 15 for the inflator 30 formed on the rear panel 12. The openings 15, 19 have substantially the same diameter.

Bolt insertion holes 20, which are aligned with the bolt insertion holes 17 of the rear panel 12, are formed around the opening 19 formed in the inner panel 13. The inner panel 13 is also formed with inner vent holes (i.e., air vents) 21 at positions relatively close to the outer peripheral edge thereof.

The peripheral portion of the opening 19 for the inflator 30 of the inner panel 13 is connected to a peripheral portion of an inflator mounting port 51 of the retainer 50. The opening 19 in the inner panel 13 is mounted together with a peripheral portion of the opening 15 for the inflator 30 of the rear panel 12. The openings 15, 19 are mounted by a retaining ring 60 via the flow control member 40.

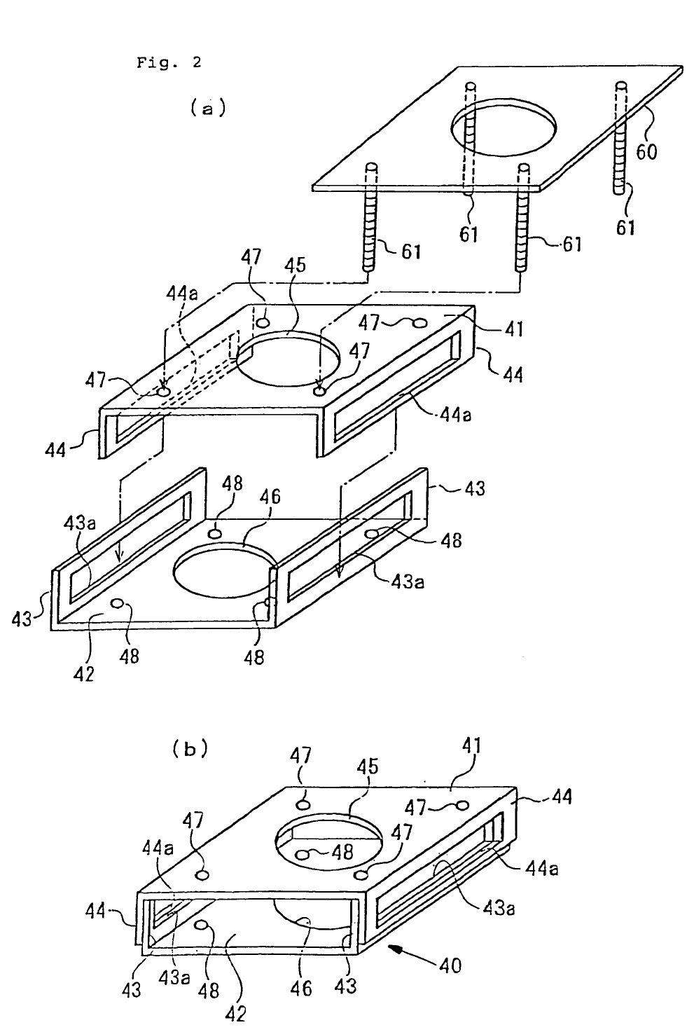

As shown in FIG. 2(a), the retaining ring 60, which is an annular member extending along the peripheral portion of the opening 19 for the inflator 30, is formed with stud bolts 61 that are to be inserted into the above-described bolt insertion holes 17, 20 of the rear and inner panels 12, 13. The stud bolts 61 project from a back surface (i.e., the surface facing the peripheral portion of the opening 19 in the inner panel 13). Bolt insertion holes 52, through which the stud bolts 61 are inserted, are formed around the inflator mounting port 51 of the retainer 50.

In this embodiment, as shown in FIGS. 2(a), (b), the flow control member 40 includes a top plate 41 and a bottom plate 42, which are opposed to each other at a predetermined distance. As shown, the top plate 41 and the bottom plate 42 are respectively formed substantially into a square flat plate. Upright members 43, 43, which extend upward at substantially right angles from sides of the bottom plate 42 toward the top plate 41, come into abutment with the lower surface of the top plate 41, i.e., the upright members 33, 33 act as spacers between the top and bottom plates 41, 42. Leg members 44, 44, which are aligned with the outwardly facing surface of the upright members 43, 43, are formed on a pair of sides of the top plate 41; the leg members 44, 44 project downward at substantially right angles from the top plate 41.

By placing the top plate 41 on the bottom plate 42, while aligning the leg members 44, 44 on the outwardly facing surfaces of the respective upright members 43, 43, the substantially box-shaped flow control member 40, which is shown in FIG. 2(b), is formed. The space formed between the top and bottom plates 41, 42 corresponds to a gas flowing space.

In this embodiment, the upright 43, 43 members and the respective leg members 44, 44 are formed with window holes 43a, 44a, which are configured for gas flow therethrough, thereby enabling the inside and the outside of the control member 40 to communicate. At the center of the top plate 41 and the bottom plate 42, openings 45, 46 for the inflator 30 are formed. The openings 45, 46, which are similar in size to the openings 19, 15 in the rear and inner panels 12, 13, are disposed concentrically with respect to each other. When the openings 45, 46 are disposed concentrically with the openings 15, 19, of the rear and inner panels 12, 13, respectively, bolt insertion holes 47, 48, which are formed around the openings 45, 46, are respectively aligned with the bolt insertion holes 17, 20 in the rear and inner panels 12, 13.

In this embodiment, the inflator 30 is formed into a substantially cylindrical shape. As previously detailed, the inflator 30 is provided with first and second gas generating units 31, 32. Although the gas generating units 31, 32 are disposed at axially different positions on a distal side of the inflator 30, the second gas generating unit 32 is disposed below the first gas generating unit 31, as shown in FIG. 1. The first and second gas generating units 31, 32 are respectively formed with gas injecting ports 31a, 32a on peripheral side surfaces thereof. The gas generating units 31, 32 respectively and radially inject gas through the gas injection ports 31a, 32a into the first and second chambers 10a, 10b.

As shown in FIG. 3, flange 33, which projects from an outer surface of the inflator 30 at an axial mid section thereof, for securing the inflator 30 is formed with bolt insertion holes 34. To assemble the inflator 30, the flange 33 is aligned with an underside of the inflator mounting port 51 of the retainer 50, after the distal end of the inflator 30 is inserted through the inflator mounting part 51. At the same time, the bolt insertion holes 34 of the flange 33 are aligned with the bolt insertion holes 52 around the inflator mounting port 51.

The airbag 10 is mounted to the retainer 50 by disposing the flow control member 40 between the inner panel 13 and the rear panel 12 (i.e., in the second chamber 10B), and aligning, with the inflator mounting port 51 of the retainer 50, each of the openings 15, 46, 45, 19 in the rear panel 12, the flow control member (i.e., the aligned holes in the top and bottom plates 41, 42), and the inner panel 13.

As a result, the distal side of the inflator 30 will be pushed through each of the openings 15, 46, 45, and 19 (as shown in FIG. 1) such that the first gas generating unit 31 is disposed in the first chamber 10A and the second gas generating unit 32 is disposed within the flow control member 40 (i.e., in the space between the top and bottom plates 41, 42 that communicates with the second chamber 10B via the window holes 43a, 44a).

Subsequently, the peripheral portion of the opening 19 for the inflator 30 in the inner panel 13 is pressed against the top plate 41 of the flow control member 40 by the retaining ring 60 from the inside of the inner panel 13 (i.e., from within the first chamber 10A). Following this, the peripheral portion of the opening 15 for the inflator 30 in the rear panel 12 is pressed against the peripheral portion of the inflator mounting port 51 of the retainer 50 by the bottom plate 42 of the flow control member 40.

Upon aligning the retaining ring 60 to the peripheral portion of the opening 19 for the inflator 30 in the inner panel 13, the stud bolts 61 of the retaining ring 60 are inserted into and through the bolt insertion holes 20, 47, 48, 17, 52, 34, and are tightened with nuts 62 screwed onto the proximal ends thereof. As a result, the rear and inner panels 12, 13 of the airbag 10, the flow control member 40, and the inflator 30 are secured to the retainer 50.

Upon stitching the front panel 11 to the rear and inner panels 12, 13 along seams 14, 18, respectively, the airbag apparatus 1 is complete. Subsequently, the airbag 10 may be folded and covered by a module cover 53 that may be attached to the retainer 50. Then, the airbag apparatus 1 and the module cover 53 may be installed in, for example, a steering wheel (only a rim portion 54 of which is shown in FIG. 1) of a vehicle such as automobile, boat, etc.

When the airbag apparatus 1 is fully assembled and installed, if the inflator 30 starts gas injection (such as when the vehicle is involved in emergency event, e.g., collision, roll-over, etc.), gas from the first gas generating unit 31 is supplied into the first chamber 10A and gas from the second gas generating unit 32 is supplied via the flow control member 40 into the second chamber 10B. As a result of the expansion of the airbag 10, the module cover 53 may be designed to split into two portions, as shown in FIG. 1, thereby allowing the airbag to expand into a passenger cabin in the vehicle. When the inflated airbag 10 hits an occupant, gas in the first and second chambers 10A, 10B escapes through the inner vent holes 21 in the inner panel 13 or through the vent holes 16 in the rear panel 12, thereby absorbing the occupant's impact.

The airbag apparatus 1 (or the vehicle) may be provided with control unit (not shown) that is configured to a activate the inflator 30 during an emergency event (e.g., a collision, roll-over, etc.) of the vehicle. Such an emergency event may be detected, for example, by a detector (not shown) that is configured to alert the control unit of the emergency event.

The control unit may have an adjusting function for adjusting an output or a timing of the activation of the first and second gas generating units 31, 32 of the inflator 30 according to one or more variables associated with a vehicle occupant such as, e.g., the occupant's weight, the occupant's physical constitution, the occupant's seated position (i.e., the distance from the steering wheel or dashboard), or other variable.

As previously discussed, when the inflator 30 (i.e., the first and second gas generating units 31, 32) starts gas injection, gas from the first gas generating unit 31 is substantially supplied only into the first chamber 10A of the airbag 10 and gas from the second gas generating unit 32 is substantially supplied only into the second chamber 10B. As a result, by independently controlling the output or the timing of activation of the first and second gas generating units 31, 32, the sequence of inflation of the first and second chambers 10A, 10B (i.e., the timing of initiation of inflation or the timing of completion of inflation) and the internal pressures therein upon inflation can be controlled independently.

For example, when the distance between the occupant and the steering wheel 54 is relatively small, or when the weight or the physical constitution of the occupant is relatively small, the output of the first gas generating unit 31 may be set to a relatively low value. Accordingly, elevation of the internal pressure and expansion toward the occupant of the first chamber 10A may be reduced, so that the occupant can be received relatively softly. In this arrangement as well, as a sufficient amount of gas may be supplied to the second chamber 10B (by the second gas generating unit 32), the entire airbag 10 can be inflated over a sufficiently wide range.

In contrast, when the distance between the occupant and the steering wheel 54 is significantly large, or when the weight or the physical constitution of the occupant is relatively large, the output of the first gas generating unit 31 may be set to a high value and the output of the second gas generating unit 32 may be set to a relatively low value. In this arrangement, sideward inflation of the airbag 10 is reduced and the entire airbag 10 is expanded largely toward the occupant. Accordingly, the occupant can be received reliably and in a relatively early stage of airbag deployment.

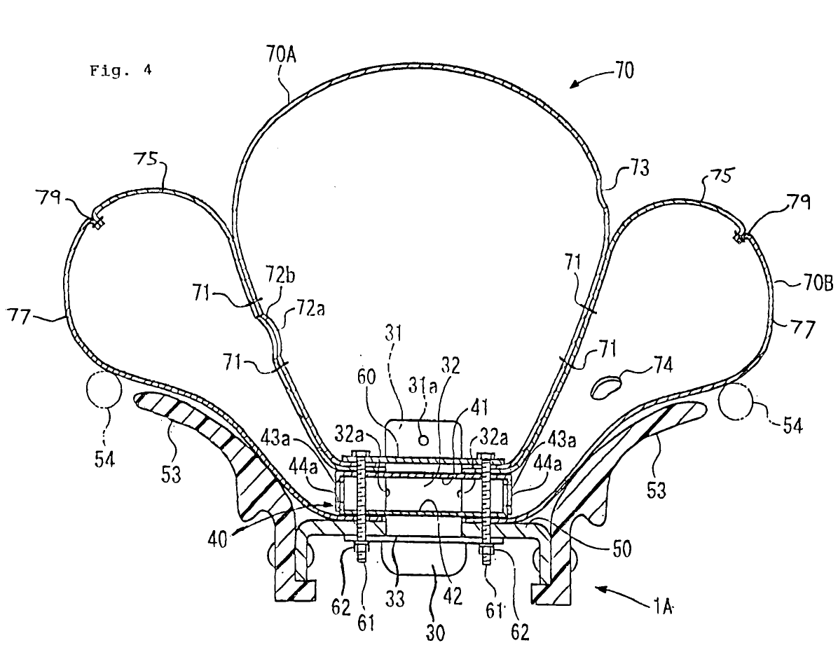

FIG. 4 is a vertical, cross-sectional view of a second airbag apparatus 1A embodiment according to present invention. In this embodiment, the airbag apparatus 1A includes an airbag 70 having first and second small airbags 70A, 70B. Whereas the first small airbag 70A may be made from one piece of material (e.g., fabric), the second small airbag 70B may be formed of two pieces of material (e.g., fabric) 75, 77 stitched together along a seam 79. For sake of viewing simplicity, only the sections of the seam 79 that are in cross-section are shown; the seam 79, however, of course circumscribes the peripheries of both pieces 75, 77 of material. Each of the small airbags 70A, 70B has a vent hole 73, 74 respectively formed therein. The vent holes 73, 74 are configured to allow gas in the respective small airbags 70A, 70B to escape.

As shown in FIG. 4, the first small airbag 70A has a substantially spherical shape in an inflated state. The second small airbag 70B is disposed behind (i.e., on the side of the first small airbag 70A opposite from the occupant-opposed surface) and circumferentially around the first small airbag 70A. The second small airbag 70B is configured to inflate in a shape that expands widely sideward (i.e., in a radial direction) around the side peripheral surface of the first small airbag 70A.

In this embodiment, the peripheral side surface of the first small airbag 70A and an intermediate area between a center portion and the peripheral portion of the front piece 75 of the second small airbag 70B are unitized by a seam 71 (e.g., stitching). The stitched surfaces of the first and second small airbags 70A, 70B are formed with aligned inner vent holes 77a, 72b, respectively. As a result, the first and second small airbags 70A, 70B communicate with each other via the inner vent holes 72a, 72b. To enhance this communication, part of the seam 71 may be extended so as to stitch around the peripheries of the inner vent holes 72a, 72b, so that the peripheral portions thereof are joined by the seam 71.

A central portion of a rear side (i.e., opposite the occupant side surface) of the first small airbag 70A has an opening (not numerically labeled) that is configure to receive the inflator 30, as shown in FIG. 4. Similarly, the second small airbag 70B has openings (not numerically labeled), which pass through both pieces 75, 77 of material, that are configured to receive the inflator 30, also as shown in FIG. 4. These openings for the inflator 30 (which are similar to the openings 19, 15 for the inflator 30 in the rear and inner panels 12, 13 shown in the embodiment in FIG. 1) may be disposed concentrically. Around the respective openings for the inflator 30, bolt insertion holes (not numerically labeled) are formed for inserting the stud bolts 61 of the retaining ring 60.

The airbag 70 is mounted to the retainer 50 by disposing the flow control member 40 within the second small airbag 70B and aligning: (a) the opening for the inflator 30 in the top plate 41; (b) the center portion of the rear end surface of the first small airbag 70A; (c) the hole through center portion of the front surface 75 of the second small airbag 70B; (d) the opening in the bottom plate 42 of the flow control member 40; (e) hole through the center portion of the second piece 77 of material; and (f) and the inflator mounting port 51 (reference numeral omitted in FIG. 4) of the retainer 50.

In this case, the distal side of the inflator 30 is inserted through the inflator mounting port 51 and the opening for the inflator 30, as shown in FIG. 4. The first gas generating unit 31, which comes first, is disposed within the first small airbag 70A, and then the second gas generating unit 32, which comes second, is disposed within the flow control member 40 (i.e., in the space between the top and bottom plates 41, 42 that communicates with the second small airbag 70B). Therefore, when the inflator 30 (i.e., the first and second gas generating units 31, 32) starts gas injection, gas from the first gas generating unit 31 is supplied into the first small airbag 70A and gas from the second gas generating unit 32 is supplied into the second small airbag 70B via the flow control member 40.

Subsequently, the peripheral portions of the openings for the inflator 30 at the center portion of the rear end surface of the first small airbag 70A and at the center of the front surface 75 of the second small airbag 70B are pressed against the top plate 41 of the flow control member 40. The peripheral portion of the opening for the inflator 30 at the center portion of the rear surface 77 of the second small airbag 70B is then pressed against the peripheral portion of the inflator mounting port 51 of the retainer 50 via the bottom plate 42 of the flow control member 40. Then, the stud bolts 61 of the retaining ring 60 may be passed through the respective bolt holes and tightened with the nuts 62 screwed onto the proximal ends thereof. As a result, the airbag 70 (i.e., the first small airbag 70A and both pieces 75, 77 of the second small airbag 70B) and the inflator 30 are secured to the retainer 50. The subsequent sequence of configuring the airbag apparatus 1A is the same as that for the airbag apparatus 1 embodiment previously discussed with respect to FIGS. 1-3.

In this airbag apparatus 1A, as previously discussed, when the inflator 30 (i.e., the first and second gas generating units 31, 32) starts gas injection, gas from the first gas generating unit 31 is substantially supplied only into the first small airbag 70A and gas from the second gas generating unit 32 is substantially supplied only into the second small airbag 70B. Therefore, by independently controlling the output or the timing of activation of the first and second gas generating units 31, 32, the sequence of inflation of the first and second small airbags 70A, 70B (i.e., the timing of initiation of inflation or the timing of completion of inflation) and the internal pressure therein upon inflation can be controlled independently.

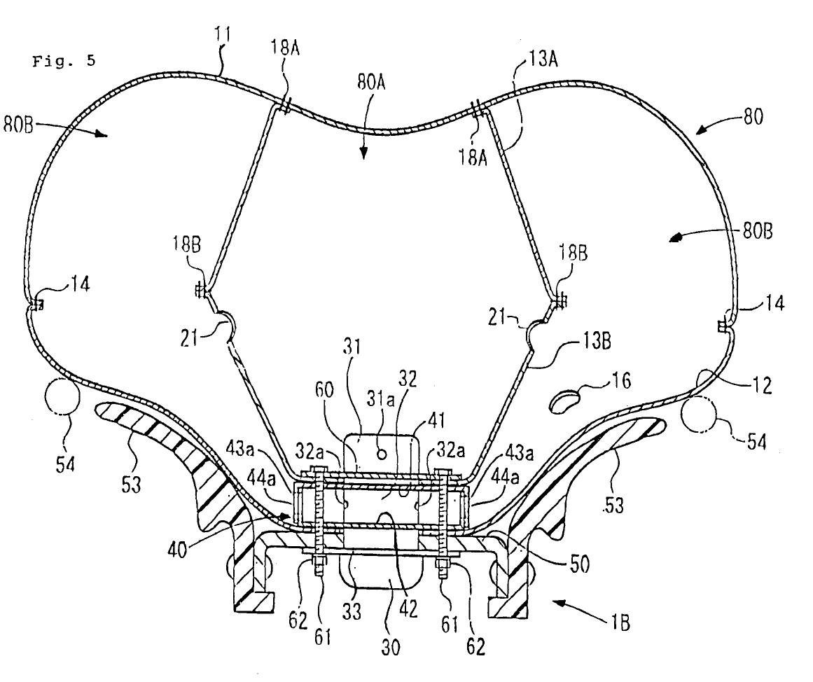

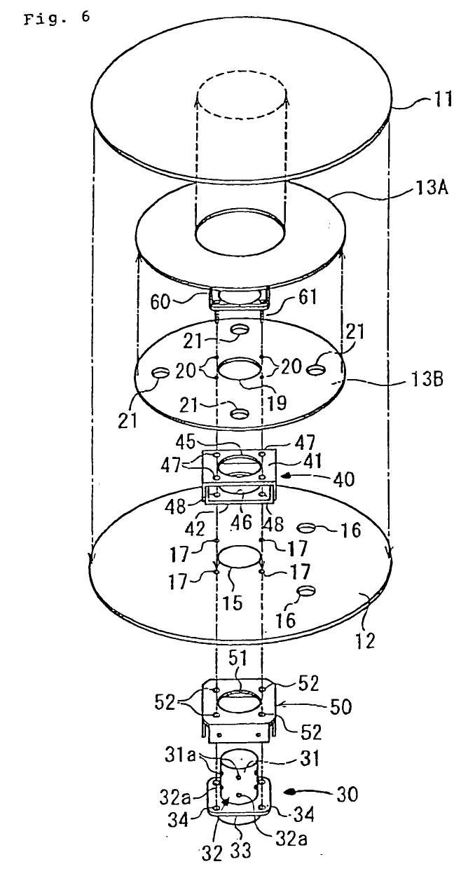

FIG. 5 is a vertical, cross-sectional view of an airbag apparatus 1B according to a third embodiment of the present invention. FIG. 6 is an exploded, perspective view of the airbag apparatus 1B shown in FIG. 5.

This airbag apparatus 1B includes: (a) an airbag 80 having the interior that is partitioned into first and second chambers 80A, 80B; (b) an inflator 30 (i.e., gas generator) for inflating the airbag 80; (c) a flow control member (i.e., gas flow path defining member) 40 that is configured to allow gas from the inflator 30 to flow independently into the first and second chambers 80A, 80B; and (d) a retainer 50 to which the airbag 80, the inflator 30, and the flow control member 40 are mounted. Other structures of the airbag apparatus 1B are the same as the airbag apparatus 1 in FIGS. 1-3.

In the airbag apparatus 1 shown in FIGS. 1-3, the interior of the airbag 10 is partitioned, by a single inner panel 13, into the first chamber 1A in the center of the airbag 10 and the second chamber 10B that surrounds the first chamber 10A. However, in the airbag apparatus 1B according to the embodiment shown in FIGS. 5-6, the interior of the airbag 80 is partitioned into the first chamber 80A and a second chamber 80B (which surrounds the first chamber 80A) by a first inner panel 13A on the front panel 11 side and a second inner panel 13B on the rear panel 12 side.

In other words, as shown in FIG. 5, in this embodiment, the first and second inner panels 13A, 13B are provided in the airbag 80. The first and second inner panels 13A, 13B are respectively disposed substantially concentrically with the front panel 11 and the rear panel 12. The outer peripheral portions of the inner panels 13A, 13B are stitched by a seam 18B formed of a yarn or the like. For sake of viewing simplicity, only the sections of the seam 18B that are in cross-section are shown; the seam 18B, however, of course circumscribes the peripheries of the inner panels 13A, 13B. The outer peripheral portion of the first inner panel 13A is stitched by a seam 18A (formed of a yarn or the like) to the front panel 11 in an intermediate portion of the front panel 11; the intermediate portion is between a center portion and a peripheral portion of the front panel 11.

As shown in FIG. 6, at a center portion of the second inner panel 13B, an opening 19 for an inflator 30 is disposed substantially concentrically with an opening 15 for an inflator in the rear panel 12; these openings 15, 19 are of substantially the same size. Around the opening 19 in the second inner panel 13B, bolt insertion holes 20, which are aligned with bolt insertion holes 17 of the rear panel 12, are provided. The second inner panel 13B is also formed with inner vent holes 21.

A retaining ring 60 is joined to the peripheral portion of the opening 19 in the second inner panel 13B, which, in turn, is joined to the peripheral portion of the opening 15 in the rear panel 12 via the flow control member 40. Subsequently, the peripheral portion of the inflator mounting port 51 of the retainer 50 is aligned with and joined to the flow control member. Accordingly, the peripheral portion of the opening 19 in the second inner panel 13B is joined to the peripheral portion of the opening 15 in the rear panel 12 via the flow control member 40. At this time, the inner peripheral portions of the first inner panel 13A and the outer peripheral portion of second inner panel 13B may be joined. In addition, the outer peripheral portion of the first inner panel 13A may be joined to the front panel 11. As a result, the interior of the airbag 80 is partitioned into the first chamber 80A (which is in a central portion of the airbag 80 and which is located inside the inner panels 13A, 13B) and the second chamber 80B (which surrounds the first chamber 80A) by the first and second inner panels 13A, 13B.

In this airbag apparatus 1B as well, the distal side of the inflator 30 inserted through the inflator mounting port 51 and through the openings 15, 19, as shown in FIG. 5. As a result, the first gas generating unit 31 is disposed within the first chamber 80A and the second gas generating unit 32 is disposed within the flow control member 40 (i.e., in the space between the top and bottom panels 41, 42 that communicates with the second chamber 80B). Therefore, when the inflator 30 (i.e., first and second gas generating units 31, 32) starts gas inflation, gas from the gas generating unit 31 is supplied into the first chamber 80A and gas from the second gas generating unit 32 is supplied into the second chamber 80B via the flow control member 40.

In this airbag apparatus 1B, as previously described, when the inflator 30 (i.e., the first and second gas generating units 31, 32) starts gas inflation, gas from the first gas generating unit 31 inflates substantially only the first chamber 80A and gas from the second gas generating unit 32 inflates substantially only the second chamber 80B. Therefore, by independently controlling the output or the timing of activation of the first and second gas generating units 31, 32, the sequence of inflation between the first and second chambers 80A, 80B (i.e., the timing of initiation or the timing of completion of inflation) and the internal pressure therein upon inflation can be controlled independently.

In this airbag apparatus 1B embodiment, as the inner panel is formed of a connected combination of the first and second panels 13A, 13B, the thickness and/or the shape of the airbag 80 upon inflation can easily be altered by adjusting the size of the first inner panel 13A and/or the second inner panel 13B.

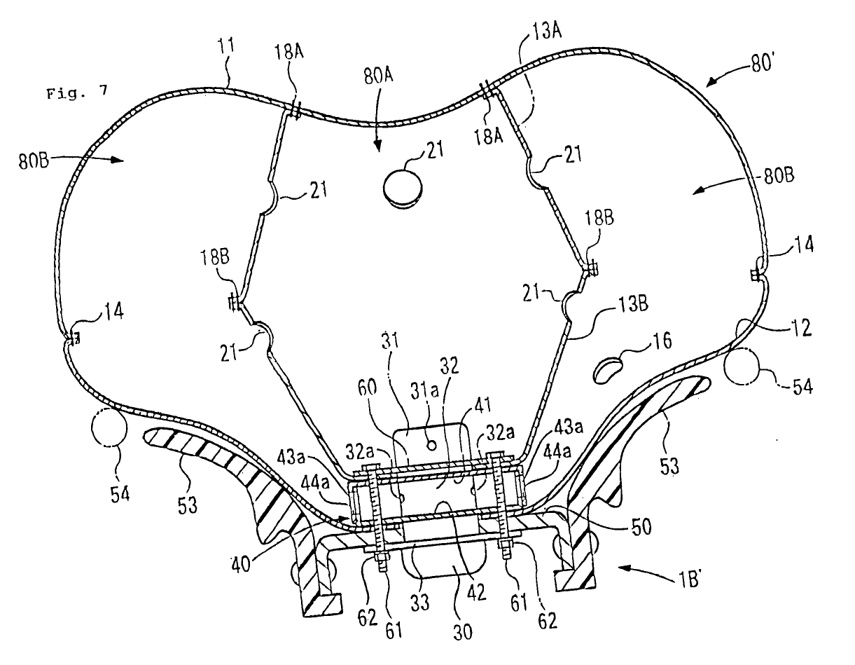

Although the inner vent holes 21 are provided on the second inner panel 13B in this embodiment, it is also possible to provide inner vent holes 21 alternatively or additionally on the first inner panel 13A. For example, FIG. 7 depicts an embodiment of an airbag apparatus 1B′ in which both of the first and second inner panels 13A, 13B of an airbag 80′ have vent holes 21. Other structures of this airbag apparatus 1B′ are the same as those in the airbag apparatus 1B shown in FIGS. 5-6.

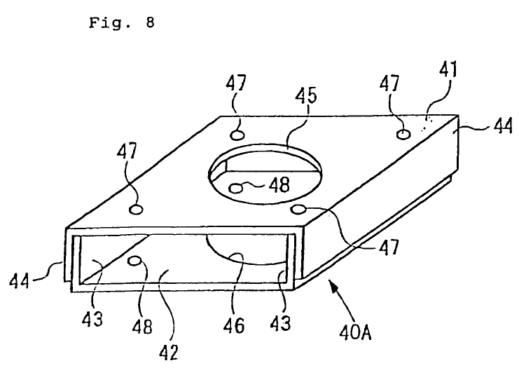

The previously embodiments are configured to have window holes 43a, 44a that are configured to allow gas to flow through the upright and leg members 43, 44. However, in some embodiments these window holes 43a, 44a may be omitted because gas also flows sideways, i.e., parallel to the upright and leg members 43, 44. FIG. 8 is a perspective view of a flow control member 40A, which lacks such window holes 43a, 44a, that can be used in any of the previously described embodiments.

In the flow control member 40A shown in FIG. 8, as the respective upright and leg members 43, 44 are not formed with window holes configured to allow gas to flow therethrough, gas injected from the inflator 30 into the flow control member 40A flows through the side surfaces of the flow control member 40A that are not covered by the upright and leg members 43, 44. In other words, whereas gas can flow out of all four sides of the previously described flow control member 40 (as a result of the window holes 43a, 44a), gas will flow out of only two sides of this alternate embodiment flow control member 40A. With the flow control member 40A thus configured, gas from the inflator can be guided in a predetermined direction toward the second chamber 10B, 80 or the second small airbag 70B.

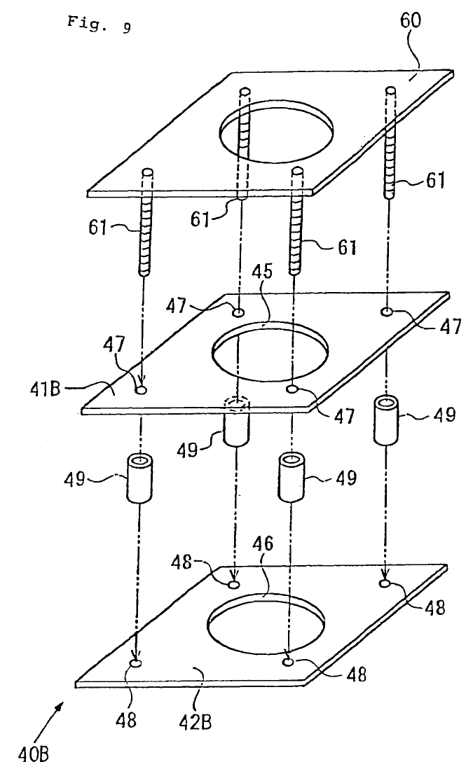

In both of previously described embodiments, the upright members 43, 43 extend from the sides of the bottom plate 42 toward the top plate 41 such that the upright members 43, 43 serve as spacers for defining a gas flow space. However, it is also possible to define the gas flow space by interposing spacer members 49 provided separately between the top and bottom plates. For example, as shown in FIG. 9, which is an exploded, perspective view of another alternate embodiment flow control member 40B, the upright and leg members 43, 44 of the previously described flow control members 40, 40A are not provided. Rather, cylindrical spacers 49, which are configured to cover the stud bolts 61, are interposed between the top and bottom plates 41B, 42B. The cylindrical spacers 49 cover the stud bolts 61, which penetrate the top and bottom plates 41B, 42B in the vertical direction. In this manner, when the gas flow space is defined by interposing the cylindrical spacers 49 (which are separable from the top and bottom plates 41B, 42B), the size of the gas flow space can easily be changed by changing the axial length of the cylindrical spacer 49.

The priority applications, Japanese Application No. 2004-030996 (which was filed Feb. 6, 2004) and Japanese Application No. 2004-064555 (which was filed on Mar. 8, 2004) are incorporated herein by reference in their entireties.

Given the disclosure of the present invention, one versed in the art would appreciate that there may be other embodiments and modifications within the scope and spirit of the invention. For example, the number of chambers to be provided in the airbag may be three or more. Similarly, the airbag may be configured of three or more small airbags. By way of further example, the partitioning member in interior of the airbag is not limited to a panel-shaped member. Rather, for example, the partitioning member may be a tether. Accordingly, all modifications attainable by one versed in the art from the present disclosure that are within the scope and spirit of the present invention are to be included as further embodiments of the present invention. The scope of the present invention is to be defined as set forth in the following claims.

1. An airbag apparatus comprising:
an airbag having a plurality of chambers; and
a gas generator configured to inflate the airbag,
wherein a supply of gas from the gas generator to at least one of the chambers is controlled independently from a supply of gas from the gas generator to other chambers.

2. The airbag apparatus according to claim 1, wherein the gas generator includes an inflator having a plurality of gas generating units that are configured to perform gas generating action independently, and wherein gas from the gas generating units is respectively supplied to the chambers.

3. The airbag apparatus according to claim 1, wherein the gas generator includes a plurality of inflators that are configured to perform gas generating action independently, and wherein gas from the inflators is respectively supplied to the chambers.

4. An airbag apparatus comprising:
a plurality of airbags; and
gas generator configured to inflate the respective airbags,
wherein a supply of gas from the gas generator to at least one of the airbags is controlled independently from a supply of gas from the gas generator to other airbags.

5. The airbag apparatus according to claim 4, wherein the gas generator includes an inflator having a plurality of gas generating units that are configured to perform gas generating action independently, and wherein gas from the gas generating units is respectively supplied to the airbags.

6. The airbag apparatus according to claim 4, wherein the gas generator includes a plurality of inflators that are configured to perform gas generating action independently, and wherein gas from the inflators is respectively supplied to the airbags.

7. A vehicle comprising:
airbag apparatus comprising:
an airbag having a plurality of chambers; and
a gas generator configured to inflate the airbag,
wherein a supply of gas from the gas generator to at least one of the chambers is controlled independently from a supply of gas from the gas generator to other chambers.

8. The vehicle according to claim 7, wherein the gas generator includes an inflator having a plurality of gas generating units that are configured to perform gas generating action independently, and wherein gas from the gas generating units is respectively supplied to the chambers.

9. The vehicle according to claim 7, wherein the gas generator includes a plurality of inflators that are configured to perform gas generating action independently, and wherein gas from the inflators is respectively supplied to the chambers.

10. A vehicle comprising:
airbag apparatus comprising:
a plurality of airbags; and
gas generator configured to inflate the respective airbags,
wherein a supply of gas from the gas generator to at least one of the airbags is controlled independently from a supply of gas from the gas generator to other airbags.

11. The vehicle according to claim 10, wherein the gas generator includes an inflator having a plurality of gas generating units that are configured to perform gas generating action independently, and wherein gas from the gas generating units is respectively supplied to the airbags.

12. The vehicle according to claim 10, wherein the gas generator includes a plurality of inflators that are configured to perform gas generating action independently, and wherein gas from the inflators is respectively supplied to the airbags.
